(19) United States
(12) Patent Application Publication
(10) Pub. No.: US 2013/0215615 A1
(43) Pub. Date: Aug. 22, 2013

(54) LATERALLY INSTALLABLE ROTATING LAMP

(71) Applicants: CHIEN-YUAN CHEN, TAIPEI CITY (TW); YING-TE CHUANG, KAOHSIUNG CITY (TW)

(72) Inventors: CHIEN-YUAN CHEN, TAIPEI CITY (TW); YING-TE CHUANG, KAOHSIUNG CITY (TW)

(73) Assignee: POWER DIGITAL DELIGHT CO., LTD., NEW TAIPEI CITY (TW)

(21) Appl. No.: 13/602,414

(22) Filed: Sep. 4, 2012

(30) Foreign Application Priority Data
Feb. 17, 2012 (TW) 101202972

(51) Int. Cl. F21V 21/26; F21V 29/00; F21V 21/00

(52) U.S. Cl. 362/249.03

(57) ABSTRACT

A laterally installable rotating lamp includes a main body, a plurality of LED light sources, a transparent cover and an electric connector. The main body includes an air flow channel disposed on one side of the main body and the LED light sources disposed on the other side of the main body, and the transparent cover covers the LED light sources, and the electric connector is installed at an end of the main body through a connecting portion and electrically coupled to the LED light sources. The air flow channel is provided for quickly dissipating the heat produced by the LED light sources to prevent a light attenuation of the LED light sources caused by the thermal interference, and a reduced service life. In addition, the connecting portion can be rotated to adjust the illumination angle or the lamp.

### CROSS-REFERENCE TO RELATED APPLICATIONS

This non-provisional application claims priority under 35 U.S.C. §119(a) on Patent Application No(s). 101202972 filed in Taiwan, R.O.C. on Feb. 17, 2012, the entire contents of which are hereby incorporated by reference.

### BACKGROUND OF THE INVENTION

1. Field of the Invention

The present invention relates to the technical field of illumination lamps, and more particularly to the design of a laterally installable rotating lamp with an air flow channel capable of overcoming the thermal interference effectively.

2. Description of the Related Art

In recent years, light emitting diode (LED) advances and features low power consumption, high light emission efficiency, high durability against damages and long service life, so that the LED is used extensively for illumination to improve the quality of our life. However, the heat produced by the LED may cause thermal interference and result in a light attenuation and a decreased service life. Obviously, conventional lamps require further improvements.

In a general LED lamp device such as an LED bulb, fins made of a highly conductive metal such as copper and aluminum are usually used to increase the thermal conduction area to improve the heat dissipation effect. However, the fins are generally installed on the backside of the LED only, and thus the thermal conduction effect is very limited. Furthermore, a transparent cover is generally installed to the front side of the LED lamp for the aesthetic, waterproof, dust-resisting and light diffusion functions, so that the heat produced by the front side of the LED cannot be dissipated by the fins or by convection. As a result, the heat dissipation effect of the fins is poor, and the fins require a relatively large design, not only incurring higher manufacturing and material costs, but also affects the aesthetic look of the product.

In addition, the LED provide a light source of direct illumination lights, so that the light is directional and generally used for projecting light to illuminate a fixed area, and the illumination range is limited which is also a major drawback of the LED bulbs. The advantages of the LED light source applied to a corresponding lamp design can maximize the illumination effect and application in our daily life.

### SUMMARY OF THE INVENTION

In view of the problems of the prior art, it is a primary objective of the present invention to provide a laterally rotating lamp that uses a U-shaped main body with an air flow channel to quickly dissipate the heat produced by the plurality of LED light sources and prevent thermal interference.

A secondary objective of the present invention is to provide a laterally installable rotating lamp, wherein the main body has a plurality of heat dissipating portions capable of dissipating the heat produced by the LED light sources to improve the heat dissipation efficiency and the light emission effect, and extend the service life effectively.

Another objective of the present invention is to provide a laterally installable rotating lamp, wherein the main body comes with a structure design that can be rotated in 360 degrees with respect to an electric connector to adjust the illumination angle and enhance the illumination effect.

To achieve the foregoing objective, the present invention provides a laterally installable rotating lamp, comprising: a main body, being a U-shaped structure, having a connecting portion disposed at an end portion of the main body, and two support arms extended from the other end portion of the main body, and an air flow channel formed between the two support arms, and a side of the main body having a disposing plane; a plurality of LED light sources, disposed on the disposing plane; a transparent cover, being a semi-circular arc cover structure, installed on a side of the main body corresponding to the LED light sources; and an electric connector, installed at the connecting portion of the main body, and electrically coupled to the LED light sources.

Wherein, the main body is made of a material selected from the collection of copper, aluminum and ceramic.

Wherein, the electric connector has a thread type setting, so that the electric connector can be secured onto a conventional light bulb holder.

In a preferred embodiment of the present invention, the laterally installable rotating lamp further comprises a plurality of heat dissipating portions disposed on the other side of the main body and corresponding to the LED light sources, and the heat dissipating portions are block structures or sheet structures installed with an interval apart from one another.

In a preferred embodiment of the present invention, the electric connector includes a pivot portion corresponding to the connecting portion and the pivot portion is pivotally coupled to the connecting portion for a 360-degree rotation for adjusting the illumination angle in order to enhance the illumination effect.

### BRIEF DESCRIPTION OF THE DRAWINGS

FIG. 1 is an exploded view of a preferred embodiment of the present invention;

FIG. 2 is a side cross-sectional view of a structure of a preferred embodiment of the present invention;

FIG. 3 is a bottom cross-sectional view of a structure of a preferred embodiment of the present invention;

FIG. 4 is a front cross-sectional view of a structure of a preferred embodiment of the present invention; and

FIG. 5 is as perspective view of another implementation mode of a preferred embodiment of the present invention.

### DETAILED DESCRIPTION OF THE PREFERRED EMBODIMENTS

The technical contents of the present invention will become apparent with the detailed description of preferred embodiments and the illustration of related drawings as follows.

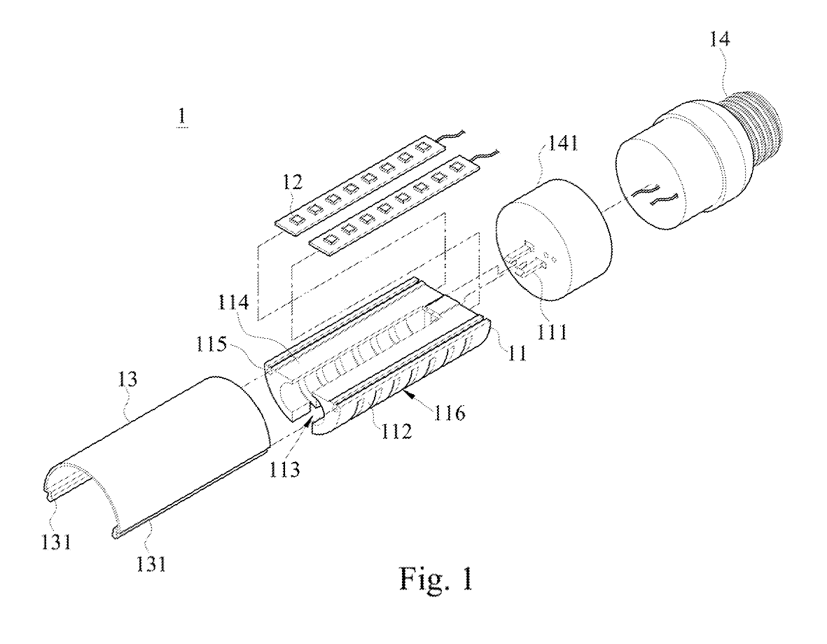

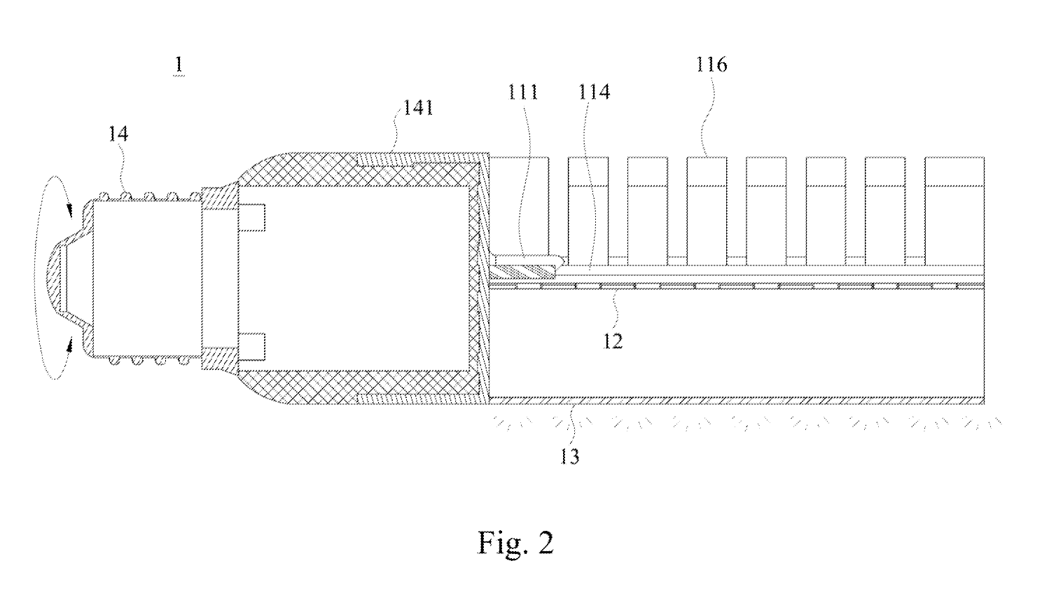

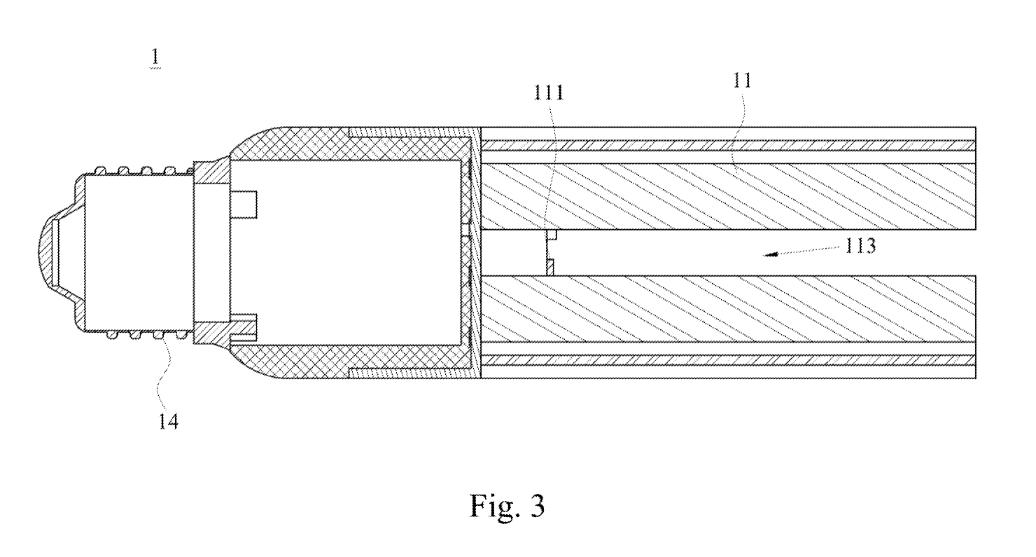

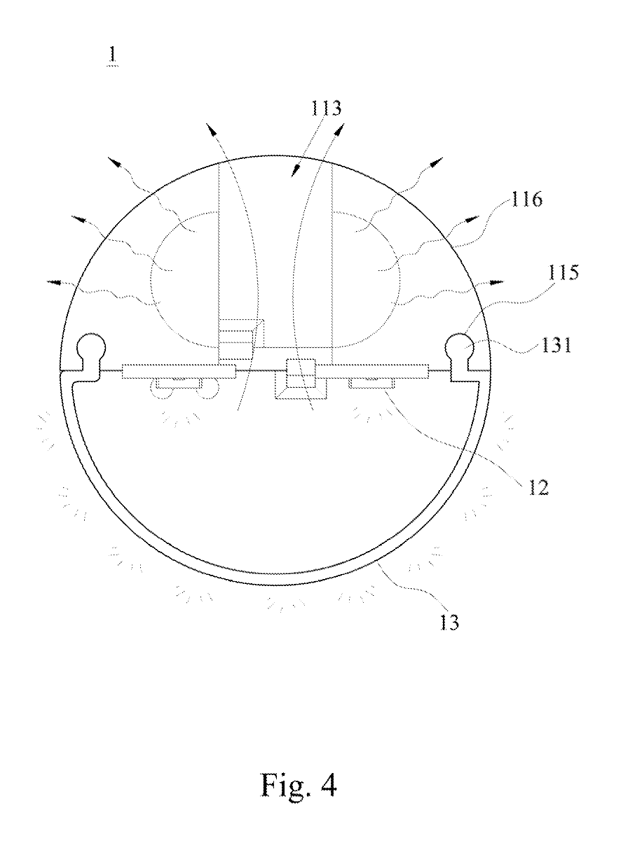

With reference to FIGS. 1 to 4 for an exploded view, a side cross-sectional view, a bottom cross-sectional view, and a front cross-sectional view of a laterally installable rotating lamp 1 in accordance with a preferred embodiment of the present invention respectively, the laterally installable rotating lamp 1 comprises a main body 11, a plurality of LED light sources 12, a transparent cover 13 and an electric connector 14.

Wherein, the main body 11 is a U-shaped structure made of a material such as copper, aluminum or ceramic, and the main body 11 has a connecting portion 111 disposed at an end portion of the main body 11, two support arms 112 extended from the other end portion of the main body 11, an air flow channel 113 formed between the two support arms 112, and a disposing plane 114 formed on a side of the main body 11. It is noteworthy that the air flow channel 113 comprised of the two support arms 112 can be formed individually on the other side of the disposing plane 114, so that the air flow channel 113 and the disposing plane 114 are not interconnected. A plurality of inward arc claw structures are disposed symmetrically on both edges of the other side of the disposing plane 114 and the air flow channel 113 is formed therein. The disposing plane 114 forms a rectangular plane with respect to the two support arms 112.

The LED light sources 12 are disposed on the disposing plane 114 as shown in the figures, and the LED light sources 12 are arranged equidistantly apart from one another and disposed on the disposing plane 114 corresponding to the pair of support arms 112 and the main body 11. However, the type, quantity and color of the LED light sources 12 are not limited to the aforementioned arrangements only.

The transparent cover 13 is a semi-circular arc cover structure made of a transparent acrylic or plastic material and installed on a side of the main body 11 and corresponding to the LED light sources 12. It is noteworthy that a snap portion 131 is formed separately on both edges of the transparent cover 13, and the main body 11 has a snap slot 115 formed thereon and corresponding to the snap portions 131 for snapping the transparent cover 13 to the main body 11, so as to improve the convenience of the installation.

The electric connector 14 has a pivot portion 141 disposed at a position corresponding to the connecting portion 111 of the main body 11, and the pivot portion 141 and the connecting portion 111 are pivotally coupled with one another, so that the main body 11 can be rotated in 360 degrees with respect to the electric connector 14, and the electric connector 14 is electrically coupled to the LED light sources 12. It is noteworthy that the electric connector 14 used in the present invention is a common E27 thread type, E26 thread type, E17 thread type, E14 thread type, E40 thread type or E39 thread type connector and so forth.

In addition, the main body 11 further includes a plurality of heat dissipating portions 116 disposed on the other side of the main body 11 and corresponding to the LED light sources 12, and the heat dissipating portions 116 are block structures or sheet structures installed with an interval apart from one another to increase the heat dissipating area on the external surface of the main body 11, so as to effectively enhance the heat dissipation efficiency.

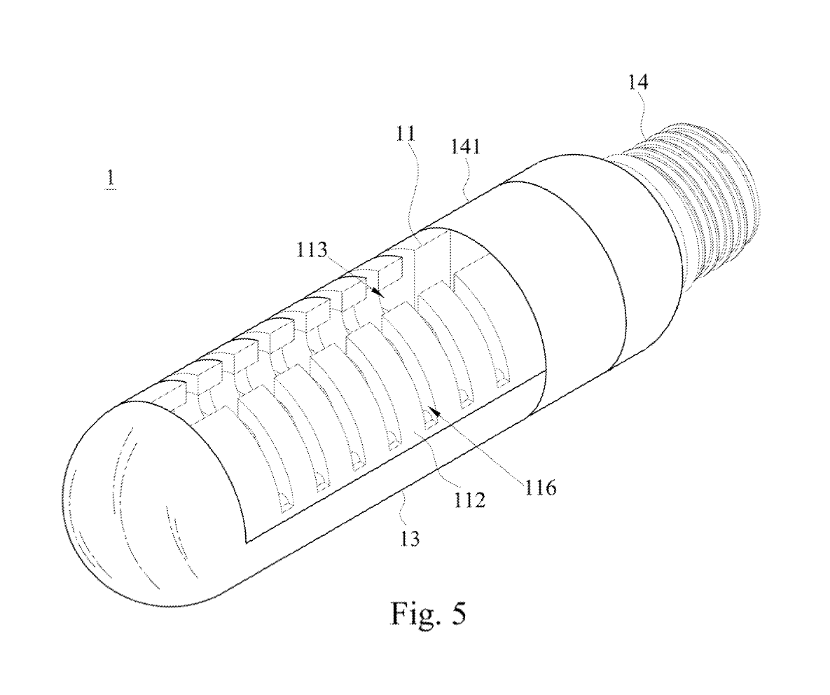

With reference to FIG. 5 for another implementation of a preferred embodiment of the present invention, the main body 11 is an O-shaped structure made of copper, aluminum or ceramic, and the remaining components and their installation method are the same as those described above, and thus will not be repeated.

In summation, the laterally installable rotating lamp 1 of the present invention adopts a design of the air flow channel 113 of the main body 11 and interconnect the inside of the transparent cover 13 to the outside, so that the heat produced by the LED light sources 12 can be dissipated through the heat dissipating portions 116 and the air flow channel 113 to prevent a light attenuation and a reduced service life caused by thermal interference. In addition, the present invention combines the connecting portion 111 and the pivot portion 141, so that the main body 11 can be rotated in 360 degrees with respect to the electric connector 14. Therefore, when the electric connector 14 is screwed to a bulb holder, the present invention still can adjust the illumination angle of the LED light sources 12 to enhance the illumination effects including the illumination angle and range effectively.

While the invention has been described by means of specific embodiments, numerous modifications and variations could be made thereto by those skilled in the art without departing from the scope and spirit of the invention set forth in the claims.

In summation of the description above, the present invention improves over the prior art and complies with patent application requirements, and thus is duly filed for patent application.

What is claimed is:

1. A laterally installable rotating lamp, comprising:
a main body, being a U-shaped structure, having a connecting portion disposed at an end portion of the main body, and two support arms extended from the other end portion of the main body, and an air flow channel formed between the two support arms, and a side of the main body having a disposing plane;
a plurality of LED light sources, disposed on the disposing plane;
a transparent cover, being a semi-circular arc cover structure, installed on a side of the main body corresponding to the LED light sources; and
an electric connector, installed at the connecting portion of the main body, and electrically coupled to the LED light sources.

2. The laterally installable rotating lamp of claim 1, wherein the main body is made of a material selected from copper, aluminum and ceramic.

3. The laterally installable rotating lamp claim 1, further comprising a plurality of heat dissipating portions disposed on the other side of the main body corresponding to the LED light sources.

4. The laterally installable rotating lamp of claim 3, wherein the heat dissipating portions are block structures installed with an interval apart from one another.

5. The laterally installable rotating lamp of claim 3, wherein the heat dissipating portions are sheet structures installed with an interval apart from one another.

6. The laterally installable rotating lamp of claim 1, wherein the electric connector has a thread type setting.

7. The laterally installable rotating lamp of claim 1, wherein the electric connector includes a pivot portion corresponding to the connecting portion and the pivot portion is pivotally coupled to the connecting portion for a 360-degree rotation.
